(19) United States
(12) Patent Application Publication
(10) Pub. No.: US 2007/0163218 A1
(43) Pub. Date: Jul. 19, 2007

(54) Composite dual layer HEPA filter

(75) Inventors: Scott Keeler, Rochester, NH (US); William H. Cambo, Rollinsford, NH (US)

Correspondence Address: BIRCH STEWART KOLASCH & BIRCH, PO BOX 747, FALLS CHURCH, VA, 22040-0747, US

(73) Assignee: Lydall, Inc., Manchester, CT (US)

(21) Appl. No.: 11/642,624

(22) Filed: Dec. 21, 2006

Related U.S. Application Data
(60) Provisional application No. 60/752,381, filed on Dec. 22, 2005.

(51) Int. Cl. B01D 46/00; B32B 3/28

(52) U.S. Cl. 55/486

(57) ABSTRACT

The invention provides a composite, dual layer filtration material (1) having a gradient structure, comprising a dust layer (2) of wet laid dust fibers (5), a HEPA layer (3) of wet laid HEPA fibers (6) laid on top of the dust layer (2), and a transition zone (4) between dust layer (2) and HEPA layer (3) of a mixture of wet laid dust fibers (5) and wet laid HEPA fibers (6), and wherein the transition zone (4) so bonds the dust layer (2) to the HEPA layer (3) such that the composite (1) may be pleated into a pleated HEPA filtration material (30) without substantial disruption of the bond between the two layers. A corresponding process is also provided.

The present invention relates to a composite filtration material, and more particularly to a composite filtration material that has filtration properties suitable for HEPA filtration applications. More particularly, it relates to such a filter material that is made of at least two layers, i.e., at least a dual layer filtration material.

### BACKGROUND OF THE INVENTION

High efficiency filtration material has been developed for removing very small particles, even in the sub-micron range, and these filters are referred to in the art as HEPA filters. While the definition of a HEPA filter is essentially set by industry standards, basically, a HEPA filter will have a minimum efficiency of 99.97% on 0.3 micron particle size at a standard flow rate. Such filters are useful, particularly, in filtration of biological applications, such as in clean rooms, biological holding cabinets, certain hospital rooms, and the like. They are also useful for protecting certain people who are allergic to small size irritants, and related afflictions. However, there is a growing tendency in the art to apply HEPA filters to a wider range of applications, even in automobiles and in homes. In these applications the filter encounters a fluid stream, e.g., air, which can be laden with considerable amounts of higher particle size materials, e.g., common household dust. Since the HEPA filtration material has exceedingly fine openings so as to intercept and trap very small particle sizes, e.g., in the sub-micron ranges, large particle dust and the like can quickly collect at the surface of the HEPA filter and substantially blind the filter. This causes an increase in pressure drop across the filter, and eventually the filter loses its effectiveness due to a reduced fluid, e. g., air, flow.

This problem is common to many other filters beside HEPA filters, and with other filters, the art has attempted to solve the problem with a dust collecting filtration material (referred to as a dust layer) placed in front of the filtration layer so the dust layer first encounters the fluid stream being filtered and removes large particles therefrom before the fluid stream contacts the filtration layer. This dust collecting material is, generally, an open web of fibers so as to not significantly increase the pressure drop of the combination filter, but with sufficient fibers to substantially intercept and hold dust particles entrained in the fluid stream to be filtered.

However, this approach with HEPA filters has encountered substantial problems. Most usually, HEPA filters are pleated so as to substantially increase the surface area of the filter media and therefore the filtration efficiency of the filter for use in a conventional HEPA pleated filter arrangements. However, when the dust layer is not firmly attached to the HEPA layer, during pleating, the dust layer and HEPA layer can shift relative to each other. This can cause thin spots in the dust layer or HEPA filter layer or breakage of the dust and/or HEPA layers, as well as produce poor pleat geometry, all of which can result in substantially less dust holding and/or filtration efficiency, particularly in removing sub-micron size particles from the fluid stream being filtered. In addition, when pleating such materials, the sharp pleat peaks can cause the dust layer and sometimes the HEPA layer to substantially separate and/or split apart, and as a result, at the sharp leading edges of the pleat peaks, the efficiency is reduced.

Various efforts have been made in the art to firmly attach the dust layer to the HEPA layer so as to avoid these problems, but the options in this regard are somewhat limited. As is quite obvious, usual stitching of the two layers together is not appropriate in a HEPA filter, since the stitch holes introduce large areas of depleted filtration efficiency. Similarly, point bonding is not acceptable, since this introduces large areas of fused material that substantially reduce the filtration surface area and increases the pressure drop. Various adhesives have also been used but, here again, if sufficient adhesive is placed between the two layers to firmly adhere the layers together, substantial blinding of the composite occurs due to the relatively large amount of adhesive required for that firm adherence of the two layers.

Accordingly, while the dual layer HEPA filter is a substantial improvement in the useful life of a HEPA filter, in that the dust layer captures large dust particles, similar to a separate pre-filter dust layer of the combination filters that would otherwise blind the HEPA layer, the dual layer HEPA filter has its own set of problems in the above regards. The art simply has not found a satisfactory solution to this difficulty with dual layer HEPA filters.

### BRIEF DESCRIPTION OF THE INVENTION

The invention is based on several primary and several subsidiary discoveries.

First, and of major importance, it was found that the dust layer and HEPA layer may be firmly secured to each other without stitching, adhesives or other extraneous materials when the dust layer and HEPA layer are assembled as a unit in a wet laying process. It is important that the dual layers be substantially simultaneously formed and that the formation is by wet laying, as opposed to more conventional manners, such as air laying, laminating and the like.

Second, and also very important, it was found that when wet laying the dust layer and HEPA layer together, they must be laid in such a manner that a transition zone is formed between the dust layer and the HEPA layer and that the transition zone is a mixture of the wet laid fibers making up the dust layer and the wet laid fibers making up the HEPA layer to obtain a gradient structure. By providing such a transition zone of that mixture of dust fibers and HEPA fibers, the transition zone forms a bond between the dust layer and the HEPA layer such that the composite of the two layers is so firmly locked together that the composite may be pleated into a pleated HEPA filter material without substantial disruption of the bond between the two layers.

As a further important discovery in this regard, it was found that in forming the transition zone certain procedures provide better transition zones. Thus, the fibers forming the dust layer are first laid in a wet laying process and partially dewatered. Thereafter, the fibers forming the HEPA layer are laid on top of the fibers forming the dust layer, and with partial dewatering of the fibers forming the HEPA layer, some of the HEPA fibers are pulled into and penetrate into the more open upper surface of the web of dust fibers so as to form the transition zone of the mixture of dust fibers and HEPA fibers. If the laying of the two layers were reversed, obviously, that penetration of the fibers would be substantially reduced, but a generally acceptable, but less desirable, product can be produced. As a subsidiary discovery in this regard, with such locking of the two layers together, the relative weights of the two layers can vary considerably, as opposed to the more restricted relative weights of the prior art. Thus, with the present firmly attached layers, the HEPA layer may be about 10-95% by weight of the composite, which wide range provides great latitude to the art in forming filtration material for specific purposes.

As a further subsidiary discovery in this regard, with such bonding of the two layers by the transition zone, the dust layer can be quite thin, e.g., from about 2 to 25 mils, and yet be firmly attached to the HEPA layer so that the composite may be appropriately pleated.

Likewise, it was found that with the present arrangement, the thickness of the HEPA layer can be quite large in its range, e.g., from 5 to 30 mils, and yet the layers will remain firmly attached to each other, even during pleating.

Thus, briefly stated, the present invention provides a composite dual layer HEPA filtration material comprising a dust layer of wet laid dust fibers, a HEPA layer of wet laid HEPA fibers, preferably, laid on the dust layer, and a transition zone, between the dust layer and the HEPA layer, of a mixture of wet laid dust fibers and wet laid HEPA fibers. That transition zone so bonds the dust layer to the HEPA layer such that the composite may be pleated into a pleated HEPA filtration material without substantial disruption of the bond between the two layers. A corresponding process is also provided.

### BRIEF DESCRIPTION OF THE DRAWINGS

FIG. 1 is a diagrammatic illustration of a side view of the composite filtration material of the present invention;

FIG. 2 is a diagrammatic illustration of a suitable process for producing the present composite; and

FIG. 3 is a diagrammatic illustration of a pleated form of the filtration material.

### DETAILED DESCRIPTION OF THE INVENTION

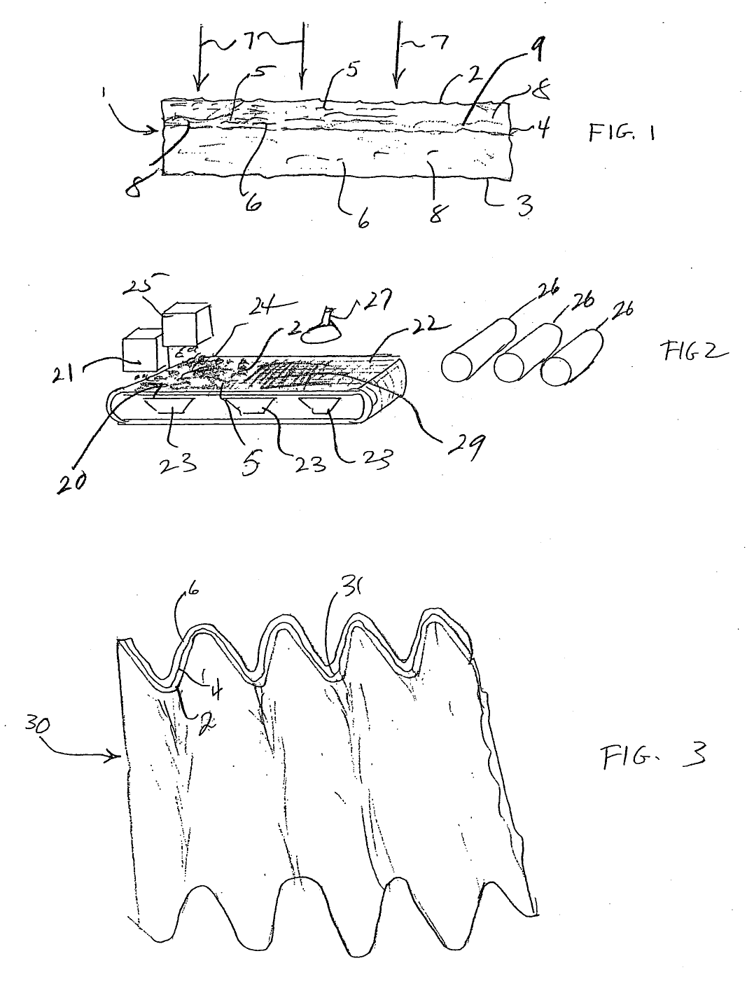

As can best been seen from FIG. 1, which is a diagrammatic illustration of a side view, the present composite filtration material, generally, (1), has an upper dust layer (2) and an underneath HEPA layer (3), with a transition zone (4). The dust layer (2) is made of wet laid dust fibers (5) (fibers intended to form the dust layer), and the HEPA layer (3) is made of HEPA fibers (6) (fibers intended to form the HEPA layer). The transition zone (4) is a mixture of dust layer fibers (5) and HEPA fibers (6). Filtration is intended to be performed with the fluid to be filtered, e.g. air, water, et cetera, shown generally by arrows (7), first encountering dust layer (2). The transition zone (4) of the mixture of dust fibers (5) and HEPA fibers (6) so bonds the dust layer (2) to the HEPA layer (3), such that the composite (1) may be pleated into a HEPA filtration material (30), generally shown in FIG. 3. That bonding is such that the filtration material may be pleated into such HEPA filtration material without any substantial disruption of the bond between the two layers. In this regard, substantial disruption is a disruption of the bond such that the two layers can substantially move relative to each other during pleating and/or use.

With such a firm attachment of the two layers by the transition zone (4), the weight of the HEPA layer (3) may vary widely, as opposed to that of the prior art, and still remain firmly attached to the dust layer (2). The HEPA layer can be from about 10-95%, and especially from about 20-60%, by weight of the composite, which gives great latitude to the filtration designer in designing the particular HEPA filter for particular applications.

Similarly, with such firm attachment, the thickness of the dust layer (2) can vary widely, e.g., from about 2-25, and especially from about 5-15, mils. Similarly, the thickness of the HEPA layer (3) can vary widely, e.g., from about 5-30, and especially from about 10-20, mils. This gives very wide latitude to the filtration designer for designing specific filters. In this regard, a particularly useful filter is one where the HEPA layer (3) has a weight of 10-70 pounds per 3,000 square feet, and the dust layer (2) has a weight of about 5-50 pounds per 3000 square feet.

The composite (1) may contain a conventional binder material (8), which is, preferably, disposed throughout the composite. Typical binders are acrylates, acrylic copolymers, polyvinyl acetate, ethylene vinyl chloride and epoxy binders, etc. The binders give desired overall stiffness and strength for pleating and the ability for the pleated material to retain the pleated configuration.

Typically, the dust fibers (5) will have an average diameter of between 2 and 10 microns, and the HEPA fibers (6) will have an average diameter of between 0.2 and 0.8 microns, although fibers outside of this range may be used if desired.

The weight of the transition zone (4), or the thickness thereof, can vary considerably, but it has been found that the transition zone is best when it is about 3% to 20% of the thickness of the composite. Thus, as little as 3% of the thickness will give an adequate bond between the two layers, and up to 20% will not substantially change the filtration characteristics of the composite (1). However, somewhat thicker transition zones are preferred, e.g., about 5 to 15%, and especially about 15%, of the thickness of the composite. This is because while the dust layer (2) will intercept and retain large dust particles to avoid early blinding of the HEPA layer (3), smaller particles can penetrate the dust layer (2) and be lodged at the upper surface (9) of the HEPA layer (3). If the particular fluid stream (7) has substantial amounts of contaminants smaller than dust size, but above sub-micron sizes, those smaller contaminants can pass through the dust layer (2) and lodge on the upper surface (9) of the HEPA layer (3) and quickly blind the HEPA layer. The transition zone (4), however, being a mixture of dust fibers and HEPA fibers, will trap, in depth, these smaller particles and will prevent those smaller particles from lodging at the upper surface (9) of the HEPA layer (3) and thus quickly binding that layer.

As can be appreciated, the greater the thickness of the transition zone, the more capacity for holding those smaller particles and preventing blinding of the HEPA layer. On the other hand, if the transition zone is too large, it will reduce the dust holding capacity of the filter material. Therefore, that thickness should not be above about 20% of the thickness of the composite.

By controlling the process for making the present composite filtration material, as described in detail below, the ratio of the dust fibers to the HEPA fibers in the transition zone can be considerably varied, e.g., the transition zone will have from about 25% to 75%, and especially from about 40% to 60%, by weight of dust fibers and likewise for the HEPA fibers. However, it has been found that for optimum bonding of the two layers and yet providing good in depth capture of smaller particles, as well as ease of manufacture, as explained more fully below, about an equal mixture of dust fibers and HEPA fibers in the transition zone is preferred.

The fibers forming the dust layer and the HEPA layer can be chosen from a wide variety of fibers, as is well known in the art and need not be detailed herein. Basically, however, the dust and HEPA fibers can be inorganic or organic fibers, and particularly glass fibers and synthetic fibers, especially polyolefin fibers, polyester fibers, and the like.

As shown in FIG. 2, which is a diagrammatic illustration of the preferred form of the process of the invention, the dual layer composite filtration material (1) is made by first wet laying a web, generally (20), of dust fibers (2) from a first head box (21) onto a formaceous body (22), which can take any of the conventional forms, such as a Fourdrinier, incline wire, rotoformer, a screen or wire belt or a perforated rotary drum, and the like. That first web (20) is partially dewatered by suction devices (23) so as to commence the formation of dust layer (2). While that dust layer (2) is commencing to form, a web (24) of HEPA fibers (6) is wet laid onto formaceous body (22) from a second head box (25). It is important to note that the dual layer HEPA product can be formed by laying the HEPA fibers first, but when the dust fibers are first laid and the HEPA fibers are laid on top of the dust fibers a much superior filtration material is produced.

The reason for the foregoing is that the dust fibers (5), first laid on formaceous body (22), will begin to form web (20) as they are dewatered by suction devices (23). However, the web is very loose and open at that time. By then wet laying the web (24) of HEPA fibers (6) from a water suspension from a second head box (25) and partially dewatering that web (24) of HEPA fibers (6), some of the HEPA fibers are pulled into and penetrate into the somewhat open upper surface (9) (FIG. 1) of dust layer (2) so as to more easily form the transition zone (4) of a mixture of dust fibers (5) and HEPA fibers (6) between the web (20) of dust fibers (5) and the web (24) of HEPA fibers (6).

It will be appreciated that the amount of HEPA fibers (6) pulled into the transition zone (4) will depend upon the extent that the web (20) of dust fibers (5) has been consolidated by dewatering before the HEPA fibers (6) are wet laid as a web (24) onto web (20) of dust fibers (5). As the dust layer (2) is being consolidated by further dewatering, the fewer HEPA fibers will penetrate into the surface thereof to form transition zone (4). Therefore, the amount of HEPA fibers in the transition zone can be controlled by the time delay in wet laying the HEPA fibers onto the forming dust fibers, the amount of suction involved in dewatering the webs, and the particular characteristics of the formaceous body. To some extent, it can also be controlled by the amount of fibers suspended in the water suspensions of the fibers. Generally speaking, such suspensions of the dust fibers and HEPA fibers will have a fiber content of about 0.01 to 1% by weight, although other amounts may be use, and by adjusting the specific fiber content in the water suspensions, some control of the percentage of HEPA fibers in the transition zone can also be controlled. Thus, by controlling these factors, the amount of HEPA fibers in the transition zone and the thickness of the transition zone can be controlled. A simple way of performing this function, once a desired amount of HEPA fibers in the transition zone has been determined, is to simply place head box (25), with the HEPA fiber suspension therein, slightly down stream of head box (21), with the suspension of dust fibers therein, as shown in FIG. 2. Of course, other layers may be laid when producing the present HEPA filtration material, e.g., for aesthetic or other purposes or functions, by adding additional head boxes with appropriate fibers therein. Alternatively, additional layers may be added after the present filtration material is produced, e. g. by laying onto the present material a further layer of material before or after pleating and all of these further layers are included within the scope of the present invention

After the webs are formed and dewatered, they are simply passed to a series of drying cans (26) to be dried in a conventional manner. The cans will be heated from about 250 to 400° F., but preferably somewhere in the range of about 275 to 350° F.

While not necessary, preferably, a binder material (8) (see FIG. 1) is sprayed onto the composite (1) by spraying device (27) for the reasons explained above or more conventionally applied as a beater add or by a saturating bath.

The amount of suction and the length of the formaceous body are chosen such that the dewatering of the so wet laid webs takes place to form a firm mat (29) of the fibers, i.e., a mat of sufficient strength that it can be pulled through drying cans (26), and be adequately dried, e.g., down to a moisture content of 1% or less.

As noted above, the ratio of HEPA fibers in the transition zone to the dust fibers in that zone can also be controlled by the consistency of HEPA fibers in the water suspension wet laid from head box (25). In addition, the placement and amount of suctions along the formaceous body can also be used to help control the amount of fibers pulled into the upper surface (9) of the forming dust layer (2) to form the transition zone (4), but when the weight of HEPA fibers and dust fibers in the transition zone is about equal, a preferred embodiment, it is best to control the fiber content of the transition zone by the placement of the head boxes and the suctions applied.

After drying the mat of fibers, that mat is then suitable for forming into a pleated filter material (30), as shown in FIG. 3. That filter material (30) will have the dust layer (2), the transition zone (4) and the HEPA layer (6). Since the transition zone (4) firmly binds the dust layer (2) to the HEPA layer (6) to form a gradient structure, the filtration material may be easily pleated with even sharp pleat peaks (31) and without substantial disruption of the bond between the two layers. This is, of course, a very decided advantage to the art by avoiding relative movement of the two layers, especially at the pleat peaks (31), since there will be no voids or separation of either the dust layer (2) or the HEPA layer (6) at those sharp peaks. Any such voids or separation, as occurs when there is relative movement between the two layers during pleating, will provide an area of less filtration material and will, therefore, more easily blind during use. If the movement is substantial enough, as can occur in the approaches of the prior art, the voids or separation can be such that HEPA specifications are not achieved as well as a reduction in dust holding from poor pleat geometry. By so binding the two layers together, as provided by this invention, that difficulty is avoided, and with the transition zone, particles smaller than dust particles will penetrate the dust layer but will be loaded and trapped, in depth, through the thickness of the transition zone so as to avoid early blinding of the HEPA layer. Tests have revealed that with a transition zone of about equal amounts of HEPA and dust fibers, and when that transition zone is about 15% of the thickness of the composite, an increase of about 40% in total loading of standard test “dust”, as described above, can be achieved, as opposed to a single layer or layered product composed of the same dust and HEPA fibers, but without a transition zone.

Accordingly, the invention provides a substantial advantage to the art.

1. A composite dual layer HEPA filtration material (1) comprising:
(A) a dust layer (2) of wet laid dust fibers (5);
(B) a HEPA layer (3) of wet laid HEPA fibers (6);
and
(C) a transition zone (4) between the dust layer (2) and the HEPA layer (3) of a mixture of wet laid dust fibers (5) and wet laid HEPA fibers (6), and wherein the transition zone (4) so bonds the dust layer (2) to the HEPA layer (3) such that the composite may be pleated into a pleated HEPA filtration material (30) without substantial disruption of the bond between the two layers and the composite is in the form of a gradient structure.

2. The composite of claim 1, wherein the HEPA layer (3) is on top of the dust layer (2) and is about 10% to 95% by weight of the composite.

3. The composite of claim 1, wherein the thickness of the dust layer is about 2-25 mils and the thickness of the HEPA layer is about 5-30 mils.

4. The composite of claim 1, wherein the HEPA layer has a weight of about 10-70 pounds per 3000 square feet and the dust layer has a weight of about 5-50 pounds per 3000 square feet.

5. The composite of claim 1, wherein the composite contains a binder material (8).

6. The composite of claim 5, wherein the binder is an acrylate, acrylic copolymer, ethylene vinyl chloride, polyvinyl acetate or epoxy binder.

7. The composite of claim 1, wherein the dust fibers have an average diameter of between 2 and 10 microns, and the HEPA fibers have an average diameter between 0.2 and 0.8 microns.

8. The composite of claim 1, wherein the transition zone is from about 3% to 20% of the thickness of the composite.

9. The composite of claim 8, wherein the transition zone is about an equal mixture of dust fibers and HEPA fibers.

10. The composite of claim 1, wherein the dust fibers and HEPA fibers are chosen from glass fibers and synthetic fibers.

11. A process for producing a composite dual layer HEPA filtration material (1), comprising
(A) wet laying a web (20) of dust fibers (5) from a water suspension thereof onto a formaceous body (22);
(B) partially dewatering the web (20) of dust fibers (5);
(C) wet laying a web (24) of HEPA fibers (6) from a water suspension thereof onto the forming web (20) of dust fibers (5);
(D) partially dewatering the web (24) of HEPA fibers (6) such that some of the HEPA fibers (6) penetrate into an upper surface (9) of the web (20) of dust fibers (5) so as to form a transition zone (4) of a mixture of dust fibers (5) and HEPA fibers (6) between the web (20) of dust fibers (5) and the web (24) of HEPA fibers (6),
(E) dewatering the so wet laid webs into a mat (29) of fibers; and
(F) drying the mat of fibers,
and wherein the transition zone (4) so bonds the dust layer (2) to the HEPA layer (3) such that the composite may be pleated into a pleated HEPA filtration material (30) without substantial disruption of the bond between the two layers and the composite is in the form of a gradient structure.

12. The process of claim 11, wherein the water suspension of the dust fibers and HEPA fibers have fiber contents of about 0.01% to 1% by weight, and the HEPA layer is about 10% to 95% by weight of the composite.

13. The process of claim 11, wherein the thickness of the dust layer is about 2-25 mils and the thickness of the HEPA layer is about 5-30 mils.

14. The process of claim 11, wherein the HEPA layer has a weight of about 10-70 pounds per 3000 square feet and the dust layer has a weight of about 5-50 pounds per 3000 square feet.

15. The process of claim 11, wherein the composite contains a binder.

16. The process of claim 15, wherein the binder is an acrylate, acrylic copolymer, ethylene vinyl chloride, polyvinyl acetate or epoxy binder.

17. The process of claim 11, wherein the dust fibers have an average diameter of between 2 and 10 microns, and the HEPA fibers have an average diameter between 0.2 and 0.8 microns.

18. The process of claim 11, wherein the transition zone is from about 3% to 15% of the thickness of the composite.

19. The process of claim 18, wherein the transition zone is about an equal mixture of dust fibers and HEPA fibers.

20. The process of claim 11, wherein the dust fibers and HEPA fibers are chosen from glass fibers and synthetic fibers.
